(19) United States
(12) Patent Application Publication
(10) Pub. No.: US 2025/0337859 A1
(43) Pub. Date: Oct. 30, 2025

(54) SYSTEM AND METHOD FOR NORMALIZING CAPTURED IMAGES OF A DYNAMICALLY SIZED PRESENTATION AREA TO PRESENT AN ORTHOGONAL AND UNOBSTRUCTED VIEW OF USER-SUPPLIED PRESENTATION MATERIAL

(71) Applicant: Dell Products LP, Round Rock, TX (US)

(72) Inventors: Chien-Chih Liao, Taipei City (TW); Karthikeyan Krishnakumar, Austin, TX (US)

(73) Assignee: Dell Products LP, Round Rock, TX (US)

(21) Appl. No.: 18/648,776

(22) Filed: Apr. 29, 2024

(51) Int. Cl. H04N 7/15; G06T 5/50; G06V 10/24; H04N 7/14

(52) U.S. Cl. CPC H04N 7/15; G06T 5/50; G06V 10/24; H04N 7/147; G06T 2207/20224

(57) ABSTRACT

An information handling system executing code instructions of a dynamic presentation area captured image normalizing system and operating a web camera hardware system to transceive data for a videoconferencing application during a videoconferencing session, the camera to capture an image of user-supplied presentation material on a planar presentation surface in a viewing area of the image, a hardware processor to execute code instructions to identify the user-supplied presentation material within the image, determine boundaries of a polygon enclosing the user-supplied presentation material, generate an orthogonal view image of an orthogonally-adjusted user-supplied presentation material by proportionally reorienting pixels of the user-supplied presentation material across a rectangular polygon to appear as orthogonally oriented to the user and a network interface device to transmit the orthogonal view image of the orthogonally-adjusted user-supplied presentation material to a remote participant in the videoconferencing session.

### FIELD OF THE DISCLOSURE

The present disclosure generally relates to a system and method for the presentation of material during videoconferencing or remote collaboration sessions. The present disclosure more specifically relates to a system and method for identifying user-supplied presentation material, such as handwriting, or drawing within images captured by a camera oriented at a non-perpendicular angle to the presentation surface, such as a whiteboard, and processing and reorienting the image to present frontal view of the user-supplied presentation material.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, video communication capabilities, and audio capabilities. The information handling system may be operatively coupled to one or more wireless peripheral input/output devices such as a web camera or video bar for videoconferencing sessions.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system with a web camera or video bar system executing code instructions of a dynamic presentation area captured image normalizing system to display an unobstructed orthogonal view of user-supplied presentation material according to an embodiment of the present disclosure;

FIG. 2A is a graphical diagram illustrating a first captured image of a viewing area including a presentation area of a planar presentation surface according to an embodiment of the present disclosure;

FIG. 2B is a graphical diagram illustrating a second captured image of the viewing area with user-supplied presentation material within the presentation area of the planar presentation surface according to an embodiment of the present disclosure;

FIG. 3 is a graphical diagram illustrating a comparative image showing differences between the first and second captured images of the viewing area with user-supplied presentation material within a presentation area of a planar presentation surface according to an embodiment of the present disclosure;

FIG. 4 is a graphical diagram illustrating an edited comparative image with objects other than user-supplied presentation material within a presentation area of a planar presentation surface removed according to an embodiment of the present disclosure;

FIG. 5 is a graphical diagram illustrating an edited comparative image including an identified polygon surrounding user-supplied presentation material within a presentation area of a planar presentation surface according to an embodiment of the present disclosure;

FIG. 6 is a graphical diagram illustrating a normalized, orthogonal frontal view image of user-supplied presentation material corrected to a rectangle of a presentation area of a planar presentation surface according to an embodiment of the present disclosure;

FIG. 7 is a graphical diagram illustrating a plurality of dynamic differences to detected size of a presentation areas identified on a planar presentation surface in which user-supplied presentation material may be provided according to an embodiment of the present disclosure;

FIG. 8 is a flow diagram illustrating a method of generating an orthogonal, frontal view image of user-supplied presentation material normalized from a presentation area of a detected planar presentation surface in a viewing area of a web camera according to an embodiment of the present disclosure; and

FIG. 9 is a flow diagram illustrating a method of identifying and displaying a series of orthogonal view images of user-supplied presentation material displayed within a presentation area of dynamically different detected shape and size as a viewing area is being captured by a web camera according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Videoconferencing applications or remote collaboration applications provide an ability for a remote participant to view, via a web camera, a viewing area of a room such as a conference room including a presenter located geographically distant from the participant to view presentation material on a presentation area of a planar presentation surface, such as a whiteboard, chalkboard, or other planar type of surface on which a presenter may write, draw, or provide other collaborative information, such as photos, or notes. A camera, such as a web camera or video conferencing bar may be placed some distance away from the presentation surface (e.g., whiteboard) in a fixed position and including hardware processing resources or operatively coupled to an information handling system to capture images of the presenter and the viewing area as they provide visual content, referred to herein as user-supplied presentation material. User-supplied presentation material may include hand writing or drawing on the planar presentation surface in the viewing area of the fixed position web camera. In existing systems, these images of a viewing area may be captured to include people or objects obscuring the information shown on the planar presentation surface that may be visible (e.g., non-obscured) to others within the same physical room as the presenter. Further, in these existing systems, the web camera may be fixed and situated at an angle other than 90 degrees from the presentation area, resulting in a skewed depiction of the user-supplied presentation material within the captured images of the planar presentation surface in the viewing area. These issues may result in poor visibility for the remote participant of the user-supplied presentation material.

Some existing systems attempt to solve these problems by adjusting the captured images to remove distortion caused by camera position that is non-orthogonal or not at a 90 degree angle from the presentation area with whiteboard boundary definitions. In order to do so, the boundaries of the presentation area must be defined and recognized within the captured images such as with “stickers” to mark boundary edges. Existing systems either provide a rigid outline of the presentation area, as defined by physical boundaries such as edges the camera is programmed to identify, or allow users to define these edges by placing physical markers recognizable by the camera around the user-supplied presentation material during the presentation. These systems thus have either a preset size limit for a presentation area, or require user interaction to consistently move the markers as needed when this presentation area changes size or shape. A system and method are needed that automatically and dynamically determines the presentation area of a planar presentation surface within a viewing area in which the presenter has supplied user-supplied presentation material, regardless of the viewing angle from the web camera. Further, a system and method are needed that automatically and dynamically determines the presentation area of a planar presentation surface within a viewing area in which the presenter has supplied user-supplied presentation material on a detected planar presentation surface with difficult to detect boundaries, such as a whiteboard glass wall, that may have a presentation area that changes in shape, size and location when the presenter organically adds or subtracts such information to different parts of the planar presentation surface having difficult to detect boundaries.

Computer executable code instructions of the dynamic presentation area captured image normalizing system in embodiments of the present disclosure address these issues by automatically determining, upon execution by a hardware processing resource, the presentation area in captured images of a viewing area from a web camera including a planar presentation surface and subtracting dynamic features from successive images while applying a normalization adjustment to provide a rectangular, normalized view of user-supplied presentation material. In additional embodiments, the computer executable code instructions of the dynamic presentation area captured image normalizing system captures from successive images of the image area the dynamically adjusting the size, shape, and orientation of this recognized presentation area of the difficult-to-detect boundaries of the planar presentation surface in the viewing area as user-supplied presentation material is added or subtracted organically by a presenter throughout the duration of a videoconferencing collaboration session. A hardware processor executing code instructions of the dynamic presentation area captured image normalizing system in embodiments may process successively captured raw images by the web camera of the viewing area the planar presentation surface, as captured from the web camera having a fixed viewing angle of the planar presentation surface and presentation area such that it may form any trapezoidal portion of the image of the viewing area in embodiments herein. Execution of the computer executable code instructions of the dynamic presentation area captured image normalizing system may operate to compare and subtract successive images from the web camera of the viewing area to identify and remove objects other than user-supplied presentation material, including those that may be dynamically movable and may obstruct the user-supplied presentation material in some images (e.g., furniture, people, etc.). Further, the execution of the computer executable code instructions of the dynamic presentation area captured image normalizing system to identifies a polygon within the images that encloses the identified user-supplied presentation material as a presentation area on the planar presentation surface. Such image processing may be achieved through the use of image differencing techniques and machine-learning object detection models.

The hardware processor executing code instructions of the dynamic presentation area captured image normalizing system may then reorient the image content within the identified polygon that contains the user-supplied presentation material in a generated orthogonal-view image such that the polygon and its contents are shifted from a trapezoidal or skewed appearance to appear to be rectangular and oriented directly in front of the camera for a viewer. This may imitate the view of a participant located within the same room as the presenter and positioned directly in front of the planar presentation surface. Such an orthogonal-view image of the user-supplied presentation material may be generated routinely throughout the presentation and provided auxiliary to the web camera image of the viewing area for example. The hardware processor executing code instructions of the dynamic presentation area captured image normalizing system may generate such an orthogonal-view image of the user-supplied presentation material at prescribed intervals or continuously, and transmit the same to remote participants, such that these remote participants may see an undistorted and unobstructed view of the user-supplied presentation material.

In addition, because the dynamic presentation area captured image normalizing system automatically determines the presentation area on a planar presentation surface in captured images of a viewing area from a web camera throughout the presentation, embodiments of the present disclosure further dynamically adjust the size and shape of the identified presentation area as the presenter adds or subtracts user-supplied presentation material within the presentation area. Further, with the increasing use of large surfaces having difficult to detect boundaries for writing or drawing during such videoconferencing sessions, such as entire windows or entire walls of a conference room, the size and shape of a presentation area in which the presenter provides such user-supplied presentation material can vary greatly during the course of a videoconferencing session and dynamic adjustment to the presentation area may be needed. This makes the use of user-adjustable boundary markers difficult and hard to maintain consistently. With the dynamic user-supplied presentation material in a presentation area or changing size of the presentation area, a dynamic presentation area captured image normalizing system in embodiments of the present disclosure can dynamically adjust the recognized content, as well as size and shape of the presentation area by automatically adjusting content in a polygon or resizing the polygon determined to enclose a presentation area having machine-recognized user-supplied presentation material, as part of the process of generating the unobscured orthogonal-view images of that user-supplied presentation material, as described above. In such a way, the hardware processor executing code instructions of the dynamic presentation area captured image normalizing system in embodiments may dynamically adjust captured images from a web camera of a viewing area of a presentation to exclude images other than the user-supplied presentation material, reorient the captured images of the presentation area and dynamically changing user-supplied presentation material therein to display from an orthogonal perspective with respect to that identified presentation area in embodiments herein. Further, the hardware processor executing code instructions of the dynamic presentation area captured image normalizing system in embodiments adaptively resize the orthogonal perspective image as the presenters change the size of the presentation area by adding or subtracting content within a hard to detect boundaries of a planar presentation surface within a viewing area capture by the web camera.

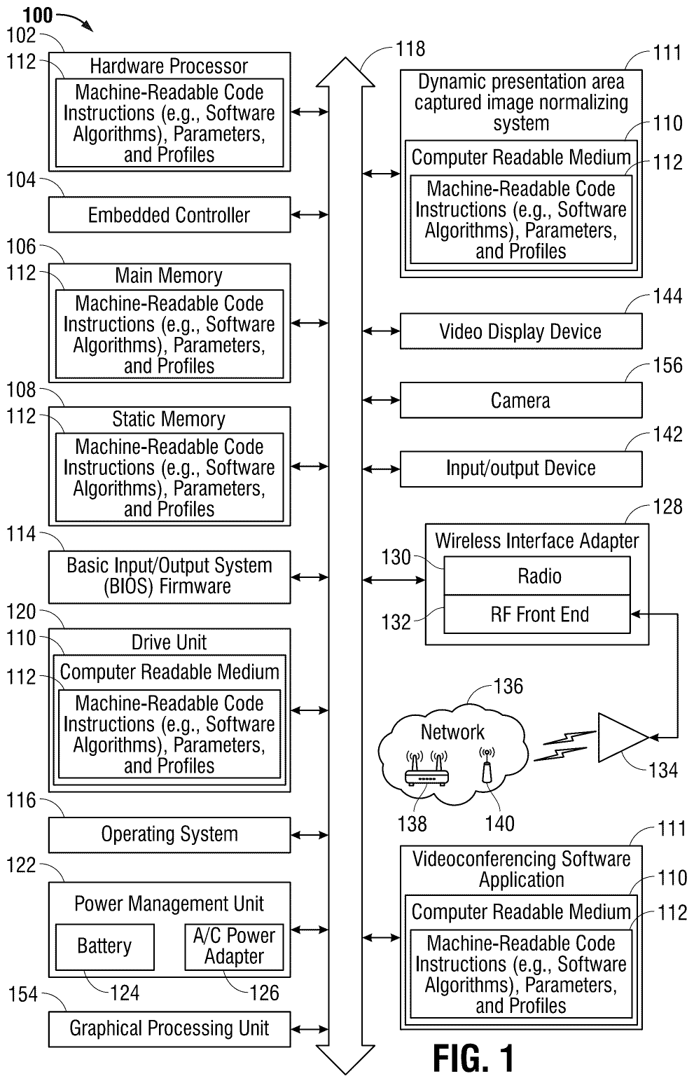

FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a videoconferencing bar, a web camera, a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 138, a base station transceiver 140, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

The information handling system 100 may include a camera 144, that operates as a web camera or a videoconferencing bar of a videoconferencing system, for capturing a plurality of images of a viewing area including user-supplied presentation material within a presentation area of a planar presentation surface oriented at a particular viewing angle that may be suboptimal, as in not orthogonal to the content, with respect to the camera 144 during a videoconferencing collaboration session. Such images may be transmitted via network 136 to remote participants in the videoconferencing collaboration session. A hardware processor 102, 104, or 154 may execute code instructions 112 of the dynamic presentation area captured image normalizing system 111 in an embodiment to dynamically adjust such captured images of a viewing area of videoconference presentation to exclude images other than the user-supplied presentation material presented in an identified presentation area on a planar presentation surface in the viewing area, and reorient the captured images to dynamically display changing content of the user-supplied presentation materials from an orthogonal perspective with respect to the identified presentation area. Further, hardware processor 102, 104, or 154 may execute code instructions 112 of the dynamic presentation area captured image normalizing system 111 in an embodiment to adaptively resize the orthogonal perspective image of the identified presentation area as the presenters change the size of the presentation area by adding or subtracting content on a planar presentation surface that may have difficult to determine boundaries in the viewing area in various embodiments.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 106, (volatile (e.g., random-access memory, etc.), or static memory 108, nonvolatile (read-only memory, flash memory etc.) or any combination thereof), one or more hardware processing resources, such as a hardware processor 102 that may be a central processing unit (CPU), a graphics processing unit (GPU) 103, embedded controller (EC) 104, or any combination thereof. Additional components of the information handling system 100 may include one or more storage devices such as static memory 108 or drive unit 120. The information handling system 100 may include or interface with one or more communications ports for communicating with external devices, as well as various input and output (I/O) devices 142, such as keyboard, video/graphics display device, a microphone, a camera 156 such as a webcam, an external speaker or headset, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 112 that may operate on servers or systems, remote data centers, or on-box in individual client information handling systems according to various embodiments herein. In some embodiments, it is understood any or all portions of instructions (e.g., software algorithms), parameters, and profiles 112 may operate on a plurality of information handling systems 100.

The information handling system 100 may include the hardware processor 102 such as a central processing unit (CPU). Any of the processing resources may operate to execute code that is either firmware or software code. Moreover, the information handling system 100 may include memory such as main memory 106, static memory 108, and disk drive unit 120 (volatile (e.g., random-access memory, etc.), nonvolatile memory (read-only memory, flash memory etc.) or any combination thereof or other memory with computer readable medium 110 storing instructions (e.g., software algorithms), parameters, and profiles 112 executable by the EC 104, hardware processor 102, GPU 103, or any other hardware processing device. The information handling system 100 may also include one or more buses 118 operable to transmit communications between the various hardware components such as any combination of various I/O devices 142 as well as between hardware processors 102, an EC 104, the operating system (OS) 116, the basic input/output system (BIOS) 114, the wireless interface adapter 128, or a radio module, among other components described herein. In embodiments herein, the information handling system 100 may be in wired or wireless communication with the I/O devices 142 and in particular to a web camera 156 or a camera 156 of a video conferencing bar for an operatively coupled videoconferencing hardware system, or the information handling system 100 may be a videoconferencing system having a web camera 156, a video display device 144, and other input/output devices 142 such as speakers and microphones. Information handling system 100 may operate as a videoconferencing hardware system or may be operatively coupled to a videoconferencing hardware system to execute code instructions 112 of a videoconferencing application 113 for operation of web camera 156, a video display device 144, and other input/output devices 142 such as speakers and microphones to conduct video and audio communications between presenters and persons in a viewing area, such as a conference room, and remote participants of the videoconferencing session.

The information handling system 100, as operatively coupled to or operating as a video conferencing hardware system further includes a video/graphics display device 144. The video/graphics display device 144 in an embodiment may function as a liquid crystal display (LCD), an organic light emitting diode (OLED), a flat panel display, a projector device to which a plurality of information handling systems may operatively couple, or a solid-state display. It is appreciated that the video/graphics display device 144 may be wired or wireless and may be an external video/graphics display device 144 that allows a user to participate in videoconferencing presentation in various embodiments herein.

A network interface device of the information handling system 100 shown as wireless interface adapter 128 can provide connectivity among devices such as with Bluetooth® or to a network 136, e.g., a wide area network (WAN), a local area network (LAN), wireless local area network (WLAN), a wireless personal area network (WPAN), a wireless wide area network (WWAN), or other network. In embodiments described herein, the wireless interface device 128 with its radio 130, RF front end 132 and antenna 134 is used to communicate with the wireless peripheral devices via, for example, Wi-Fi, Wi-Fi Direct®, Bluetooth® or Bluetooth® Low Energy (BLE) protocols. In an embodiment, the WAN, WWAN, LAN, and WLAN may each include an AP 138 or base station 140 used to operatively couple the information handling system 100 to a network 136. In a specific embodiment, the network 136 may include macro-cellular connections via one or more base stations 140 or a wireless AP 138 (e.g., Wi-Fi), or such as through licensed or unlicensed WWAN small cell base stations 140. Connectivity may be via wired or wireless connection. For example, network wireless APs 138 or base stations 140 may be operatively connected to the information handling system 100. In other embodiments, the RF front end 132 may establish a Wi-Fi Direct® wireless link adhering to the Wi-Fi protocols, but without the use of a wireless AP 138 or base station 140. Wi-Fi Direct® may provide for a direct, single hop link between the information handling system 100 and any one of the peripheral devices 142, or among a plurality of such peripheral devices 142.

Wireless interface adapter 128 may include one or more radio frequency (RF) subsystems (e.g., radio 130) with transmitter/receiver circuitry, modem circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi Direct®, Wi-Fi 6E, 6 GHz)), IEEE 802.15 WPAN standards, WWAN such as 3GPP or 3GPP2, Bluetooth® standards, or similar wireless standards may be used. Wireless interface adapter 128 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes instructions, parameters, and profiles 112 or receives and executes instructions, parameters, and profiles 112 responsive to a propagated signal, so that a hardware device connected to a network 136 may communicate voice, video, or data over the network 136 such as via execution of code instructions 112 of a videoconferencing application 113 when operating as or with a videoconferencing hardware system including web camera 156 and display device 144. Further, the instructions 112 may be transmitted or received over the network 136 via the network interface device or wireless interface adapter 128.

The information handling system 100 may include a set of instructions 112 that may be executed to cause the computer system to perform any one or more of the methods or computer-based functions disclosed herein. For example, instructions 112 may be executed by a hardware processor 102, GPU 103, EC 104 or any other hardware processing resource and may include software agents, or other aspects or components used to execute the methods and systems described herein. Various software modules comprising application instructions 112 may be coordinated by an OS 116, and/or via an application programming interface (API). An example OS 116 may include Windows®, Android®, and other OS types. Example APIs may include Win 32, Core Java API, or Android APIs. Computer readable code instructions 112 may include a videoconferencing application and a dynamic presentation area captured image normalization system 111 according to embodiments of the present disclosure.

In an embodiment, the information handling system 100 may include a disk drive unit 120. The disk drive unit 120 and may include machine-readable code instructions, parameters, and profiles 112 in which one or more sets of machine-readable code instructions, parameters, and profiles 112 such as firmware or software can be embedded to be executed by the hardware processor 102 or other hardware processing devices such as a GPU 103 or EC 104, or other microcontroller unit to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 103 of information handling system 100.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102 and other hardware components described herein. The PMU 122 may control power to one or more components including the one or more drive units 120, the hardware processor 102 (e.g., CPU), the EC 104, the GPU 103, a video/graphic display device 144, or other wired I/O devices 142 and other components that may require power when a power button has been actuated by a user. In an embodiment, the PMU 122 may monitor power levels and be electrically coupled to the information handling system 100 to provide this power. The PMU 122 may be coupled to the bus 118 to provide or receive data or machine-readable code instructions. The PMU 122 may regulate power from a power source such as the battery 124 or AC power adapter 126. In an embodiment, the battery 124 may be charged via the AC power adapter 126 and provide power to the components of the information handling system 100, via wired connections as applicable, or when AC power from the AC power adapter 126 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

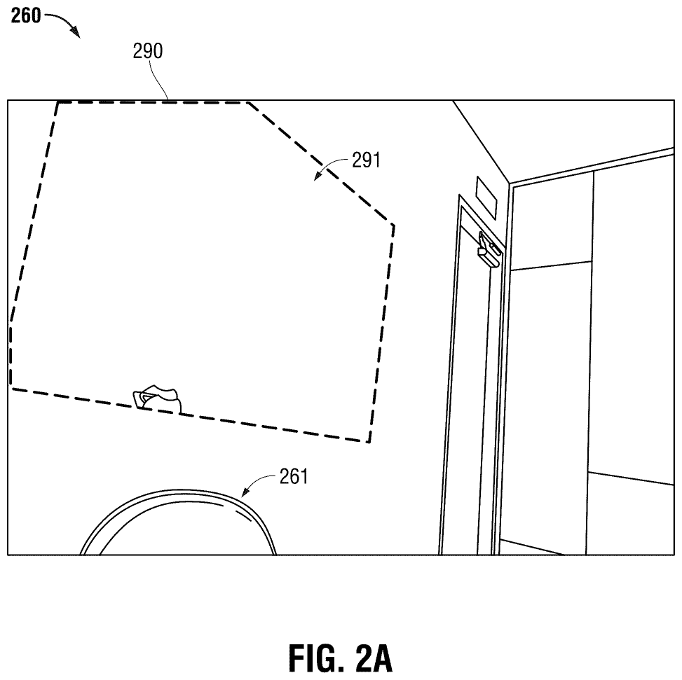

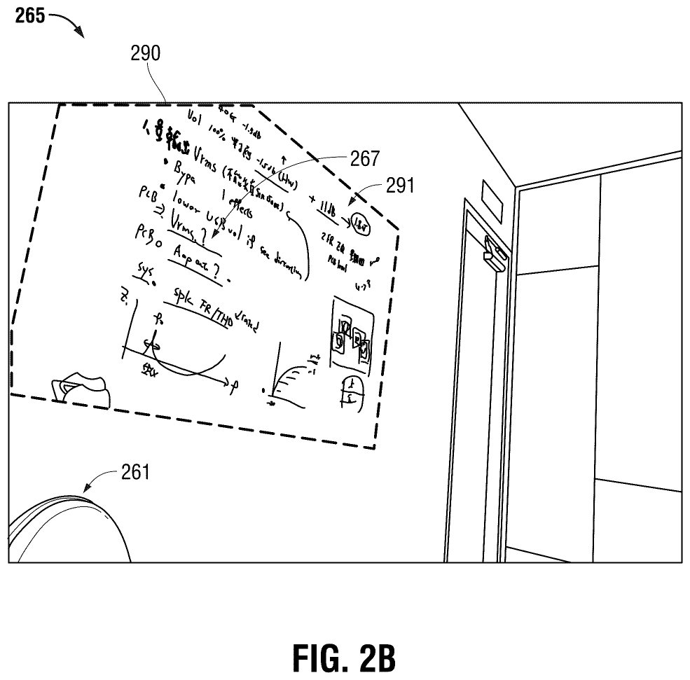

FIG. 2A is a graphical diagram illustrating a first captured image of a viewing area of a video conference room having a presentation area of a planar presentation surface where presenter may draw or attach user-supplied presentation material, as captured from a videoconference web camera oriented at a viewing angle with respect to the presentation area according to an embodiment of the present disclosure. Upon the start of a collaborative presentation session, such as a video-conference or web presentation session between participants in different locations (e.g., different rooms or different geographic locations), a presenter may need to provide user-supplied presentation material within an initial presentation area 290 of a planar presentation surface 291 that may be in the video conference room of the image 260. A camera, such as a webcam or video bar may be placed at an angle, which may or may not be perpendicular to the planar presentation surface 291 thus making recorded images of the user-supplied presentation material as the presenter adds this material (e.g., through hand writing or drawing) to the planar presentation surface 291, such as a whiteboard, for example difficult to view.

The captured image 260 may be the first of a plurality of images that may be captured in an embodiment. Such a captured image 260 may not yet include user-supplied presentation material, such as in image 265 of FIG. 2B that may include handwriting, drawings, photos, or other user-supplied media placed by the user within a presentation area 290 of a planar presentation surface 291, such as a bulletin board, dry-erase board, chalkboard, or any physical surface in which a user may write or draw. The camera capturing such images may be oriented at a viewing angle with respect to the presentation area 290 and the planar presentation surface 291 that is less than optimal for viewing any user-supplied presentation material that may be provide by a presenter. This viewing angle may be anywhere from one to ninety degrees. The captured image 260 may further capture objects surrounding the planar presentation surface 291 that may be located between the camera and the planar presentation surface 291, such as the office chair 261, in various embodiments. In some cases, these objects may include the presenter, other participants of the session within the same physical room as the presenter, or any number of other objects that may obscure the camera's view of the presentation area 290 and the planar presentation surface 291 in the video conference room in the image 260.

FIG. 2B is a graphical diagram illustrating a second captured image of user-supplied presentation material within a presentation area of a planar presentation surface, as captured from a camera oriented at a viewing angle with respect to the presentation area according to an embodiment of the present disclosure. As the collaborative presentation session progresses, one or more presenters may provide additional user-supplied presentation material 267 or remove such user-supplied presentation material through erasing. This addition or subtraction of user-supplied presentation material 267 may be modified and adjusted to an orthogonal, frontal view presented to a remote participant to be viewable better than the user-supplied presentation material 267 as skewed from the angle to the identified presentation area 290 of the planar presentation surface 291 in the image 265. Further, in some embodiments a user adding user-supplied presentation material may cause the portion of the planar presentation surface 291 in which such user-supplied presentation material 267 is provided to increase or decrease throughout the duration of the session and may cause an updated, identified presentation area 290 adjusted as to size.

The captured image 265 of the user-supplied presentation material 267 taken as the session progresses may be the second or later of a plurality of images that may be captured by the web camera during a videoconference session in an embodiment. Such a second captured image 265 may include user-supplied presentation material 267 that was placed within a presentation area 290 for a planar presentation surface 290 that appears in the viewing area captured by the web camera in the second captured image 265. The captured image 265 may further capture objects surrounding the planar presentation surface 291 and that may be located between the web camera and the planar presentation surface 291, such as the office chair 261, in various embodiments. As can be seen by comparing FIGS. 2A and 2B, the office chair 261 may have changed positions or location with respect to the camera capturing the images 260 and 265, such that the position of the office chain 261 within the frame of the image 265 has changed in comparison to the image 260 of FIG. 2A. As with FIG. 2A, other objects may be captured within the image 265, such as the presenter, other participants of the session within the same physical room as the presenter, or any number of other objects that may obscure the camera's view of the user-supplied presentation material 262.

As described below, these raw captured images 260 of FIG. 2A and 265 of FIG. 2B may undergo image processing techniques to filter out and provide a focused view of the user-supplied presentation material 267 during the videoconference session. However, it may also be beneficial for participants to view the raw unprocessed images, including 260 and 265, of the videoconference video feed as they are being recorded in order to more fully participate in the videoconference and understand the ways in which the participants in the same room with the planar presentation surface 291 interact with that planar presentation surface 291 in embodiments herein. Thus, in some embodiments, the video feed including periodically captured images, such as 260 of FIG. 2A and 265 of FIG. 2B, may be displayed alongside the later processed image that provides an orthogonally normalized view of the user-supplied presentation material 267 pursuant to execution of code instructions of the dynamic presentation area captured image normalizing system by a hardware processor at the web camera system or an information handling system operatively coupled to the web camera in various embodiments herein.

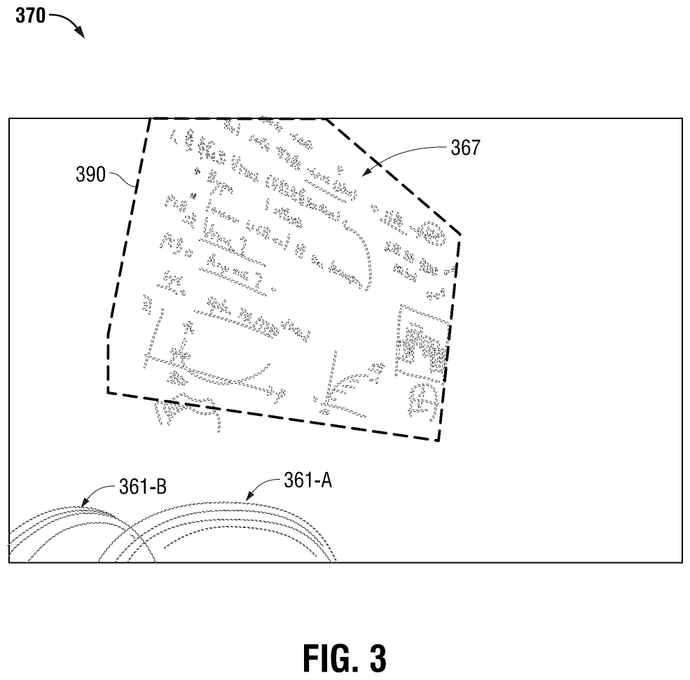

FIG. 3 is a graphical diagram illustrating a comparative image combining a plurality of successively captured raw images of user-supplied presentation material within a presentation area of a planar presentation surface in images of a web camera viewing area via execution of code instructions of the dynamic presentation area captured image normalizing system according to an embodiment of the present disclosure. In order to present an orthogonal, normalized image of the user-supplied presentation material 367, such as hand writing or drawing for example, a subtractive function between the first and second captured images of a viewing area such as the web camera view of a video conference room may be conducted to identify differences in a comparative image 370. For example, image 260 of FIG. 2A has no user-supplied presentation material whereas image 265 of FIG. 2B docs. Subtraction between those two captured images in a comparative image 370 highlights the user-supplied presentation material 367 in the resulting comparative image shown in FIG. 3. Further, objects such as chair 361-A and 361-B that may have been moved are shown as well in the subtractive image 370 of FIG. 3. Further, any objects that may have obscured the user-supplied presentation material 367 may be removed from comparison of additional successive captured images. An image differencing algorithm may be applied in an embodiment, via a hardware processor executing code instructions of the dynamic presentation area captured image normalizing system at a web camera system or an information handling system operatively coupled or networked to the web camera, to successively captured images, such as those described above with respect to FIGS. 2A and 2B. In order to perform such an image differencing or image subtraction method, the successively captured images may first be spatially aligned with one another to match features between them. Thus, the hardware processor executing code instructions of the dynamic presentation area captured image normalizing system may combine the successively captured images 260 and 265 from FIGS. 2A and 2B, respectively, into a comparative image 370 where one or more features of these images are aligned with one another, such as one or more edges of the presentation area 390, such as of a planar presentation surface 291 of FIGS. 2A and 2B, that is a border of an identified presentation area if one is available in both successive captured images in an embodiment.

Because the position of the camera with respect to the presentation area 390 of the planar presentation surface (e.g., whiteboard) does not change, any changes in the location of other objects within the frame of the comparative image 370 may indicate the presence of an object or person that has moved or could obscure the view of the user-supplied presentation material 367. For example, the comparative image 370 may include a first image of chair 361-A in a first position taken from the underlying captured image 260 of FIG. 2A, and a second image 361-B of the same office chair in a second position taken from the underlying captured image 265 of FIG. 2B. A hardware processor executing code instructions of an image differencing algorithm of the dynamic presentation area captured image normalizing system may compare pixel values of the comparative image 370 to identify objects, such as 361-A and 361-B that have moved between successively captured images underlying the comparative image 370. Any type of image differencing algorithm known in the art or later developed may be used, such as image subtraction, pixel subtraction, or difference imaging techniques.

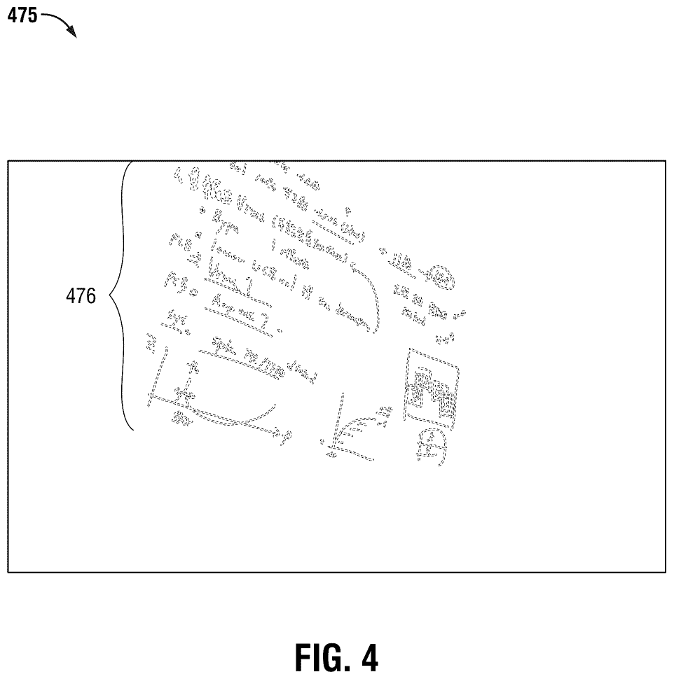

FIG. 4 is a graphical diagram illustrating an edited comparative image in which objects other than user-supplied presentation material have been removed from within a presentation area of a planar presentation surface, as generated based on images captured from a camera oriented at a viewing angle with respect to the presentation area that may not have an optimal view of the user-supplied presentation material according to an embodiment of the present disclosure. A hardware processor executing code instructions of the dynamic presentation area captured image normalizing system may identify user-supplied presentation material 476 as well as objects other than user-supplied presentation material 476 within the comparative image (e.g., chair 361-A and 361-B of comparative image 370 of FIG. 3). An object recognition algorithm or image recognition algorithm may be executed with the dynamic presentation area captured image normalizing system to identify the user-supplied presentation material 476 and the other object from the comparative image (e.g., 370 of FIG. 3). Next the dynamic presentation area captured image normalizing system may execute an editing algorithm to remove other objects that are not identified as the user-supplied presentation material 476 from the image frame in order to ensure a clear view of the user-supplied presentation material 476 in the edited comparative image 475 of FIG. 4. Such edited other objects may occupy different positions within frames of successively captured images such that artefacts of the moved object in the resulting comparative image 370 of FIG. 3 may be edited from the edited comparative image 475 of FIG. 4.

As described above, a hardware processor executing code instructions of an image recognition algorithm of the dynamic presentation area captured image normalizing system in embodiments herein identifies the user-supplied presentation material 476 as human generated or added forms or image components in a presentation area, such as 390 in the comparative image 370 of FIG. 3 as identify well as other objects, such as 361-A and 361-A that have moved between successively captured images underlying the comparative image 370 of FIG. 3 and which may need to be edited out. In a particular aspect of an embodiment, the hardware processor executing code instructions of the dynamic presentation area captured image normalizing system may further identify human writing, drawing, or other user-supplied presentation material 476, as captured within the edited comparative image 475 with an object recognition or image recognition algorithm. Any known or later-developed object detection algorithm or method may be used in an embodiment, including machine-learning, deep-learning, or neural network techniques. Example embodiments may include a histogram of oriented gradients technique, region-based convolutional neural networks, single-shot detector techniques, “you only look once” (YOLO) techniques, or a RetinaNet model.

The hardware processor executing code instructions of an image editing algorithm of the dynamic presentation area captured image normalizing system may further generate an edited comparative image 475 in an embodiment by removing those identified objects (e.g., 361-A and 361-B from FIG. 3), leaving the user-supplied presentation material 476. Further, the image or object recognition algorithms and editing algorithms applied to a comparative image such as 390 may be applied to plural successive captured images, such as three captures images, such that any obstruction of the user-supplied presentation material 476 may also be removed and edited out in some embodiments. In other embodiments, a captured image including an object identified as obstructing the user-supplied presentation material 476 may be rejected and another second image captured of the viewing area by the web camera to obtain a focused image of the user-supplied presentation material 476 for use with the algorithms described above of the dynamic presentation area captured image normalizing system described herein.

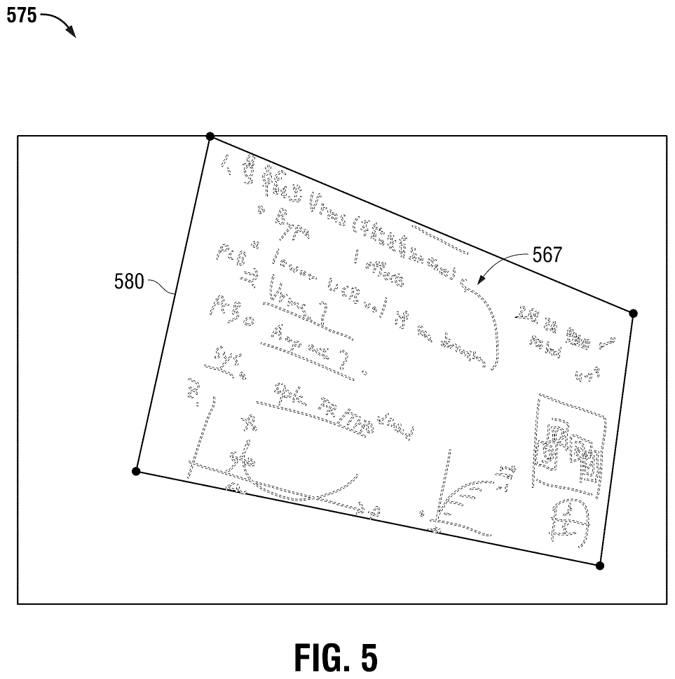

FIG. 5 is a graphical diagram illustrating an edited comparative image including an identified polygon surrounding user-supplied presentation material within a presentation area of a planar presentation surface, generated based on images captured from a camera oriented at a viewing angle with respect to the presentation area according to an embodiment of the present disclosure. Upon detection of the user-supplied presentation material 567, as described directly above, the hardware processor executing code instructions of the dynamic presentation area captured image normalizing system in an embodiment may determine the boundaries of a polygon 580 enclosing the identified user-supplied presentation material 567. The polygon 580 may be a trapezoidal polygon shape in some example embodiments due to the skew from the viewing angle of the web camera capturing the imaging view of the videoconference room including the planar presentation surface. The polygon 580 may also represent the same or similar boundaries to those of the identified presentation area described above and formed around the user-supplied presentation material 567 within the edited comparative image 575. As can be seen in FIG. 5, the camera that captured the raw images used to generate the edited comparative image 575 is oriented at an angle (e.g., not perpendicular or orthogonal to) the planar presentation surface upon which the user-supplied presentation material 567 has been provided giving a skew view of the user-supplied presentation material 567. Thus, in order to provide a clearer view of the user-supplied presentation material 567, the polygon 580 may be used along with the user-supplied presentation material 567 to adjust orthogonally the content of the user-supplied presentation material 567 to proportionally fit into a rectangular, front-facing orthogonal presentation of the user-supplied presentation material 567 such as may be viewed by a participant within the same room and sitting directly in front of the user-supplied presentation material 567. The pixels of user-supplied presentation material 567 in the trapezoidal polygon 580 of the edited comparative image 575 are adjusted to reorient the user-supplied presentation material 567 to fit proportionally across a rectangle polygon to present the user-supplied presentation material 567 at an orthogonal angle at which the viewer sees the user-supplied presentation material 567.

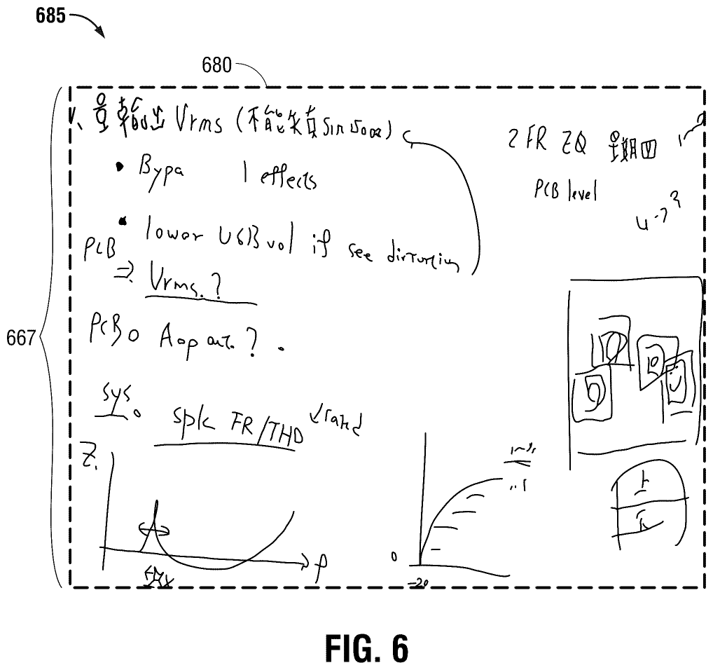

In order to do this, the hardware processor executing code instructions of the dynamic presentation area captured image normalizing system in an embodiment may determine the boundaries of a polygon 580 enclosing the identified user-supplied presentation material 567. To a viewer within the room and sitting directly in front of this user-supplied presentation material 567, such a polygon may appear as a rectangular area (e.g., with ninety degree angles). Since the polygon 580 shown in the edited composite image 575 may have acute or obtuse angles of a trapezoidal polygon due to the distortion caused by the camera angle, a translation is conducted of the pixels within the trapezoidal polygon 580, including the user-supplied presentation material 567, into a rectangular polygon (e.g., shown in FIG. 6) and the translation proportionally distributes the pixels of the user-supplied presentation material 567 across the rectangular polygon as described in greater detail below with respect to FIG. 6. In such a way, the edited comparative image 575 may be further adjusted to reorient the angle at which the viewer sees the user-supplied presentation material 567 to remove this distortion.

FIG. 6 is a graphical diagram illustrating an orthogonal unobstructed view image of user-supplied presentation material detected and identified as provided within a presentation area of a planar presentation surface in captured images of a viewing area by a web camera that is generated based on successive images captured from a camera oriented at a viewing angle with respect to the presentation area according to an embodiment of the present disclosure. A hardware processor executing code instructions of the dynamic presentation area captured image normalizing system in an embodiment may generate an orthogonal view image 685 of the orthogonally-adjusted user-supplied presentation material 667 within the presentation area outlined by the polygon 680. This may be done by reorienting the pixels from a portion of the edited comparative image having the user-supplied presentation material (e.g., 567 of FIG. 5) and lying within the polygon (e.g., 580) to appear as proportionally distributed across a flat, rectangular presentation area polygon that encloses the orthogonally-adjusted user-supplied presentation material 667. In such a way, the hardware processor executing code instructions of the dynamic presentation area captured image normalizing system in an embodiment may dynamically adjust captured images of a presentation to exclude images of other objects in the viewing area other than the orthogonally-adjusted user-supplied presentation material 667, and reorient the captured images of the user-supplied presentation material to display within an orthogonal view image of the orthogonally-adjusted user-supplied presentation material 667. This is done, according to embodiments herein, by the hardware processor executing code instructions of the dynamic presentation area captured image normalizing system to translate the set of pixels of the user-supplied presentation material 567 that is skewed and within an identified trapezoidal polygon 580 as described in FIG. 5 to proportionally appear across a pixel area of the orthogonally-adjusted user-supplied presentation material 667 within a rectangular polygon 680 to provide an orthogonal perspective with respect to the presentation area, as would be viewed by a participant within the same room as the presentation area.

A series of such orthogonal view images (e.g., 685) may be generated throughout the duration of a presentation session, as user-supplied presentation material is added or subtracted from the planar presentation surface. Each of these generated orthogonal view images 685 may be stored or displayed to remote session participants. In some embodiments, such an initial orthogonal view image 685 may be displayed alongside a video feed of the videoconference from which the most recently captured raw images (e.g., 265 of FIG. 2B) of the presentation area are pulled and may include updates to the user-supplied presentation material as the videoconference session progresses.

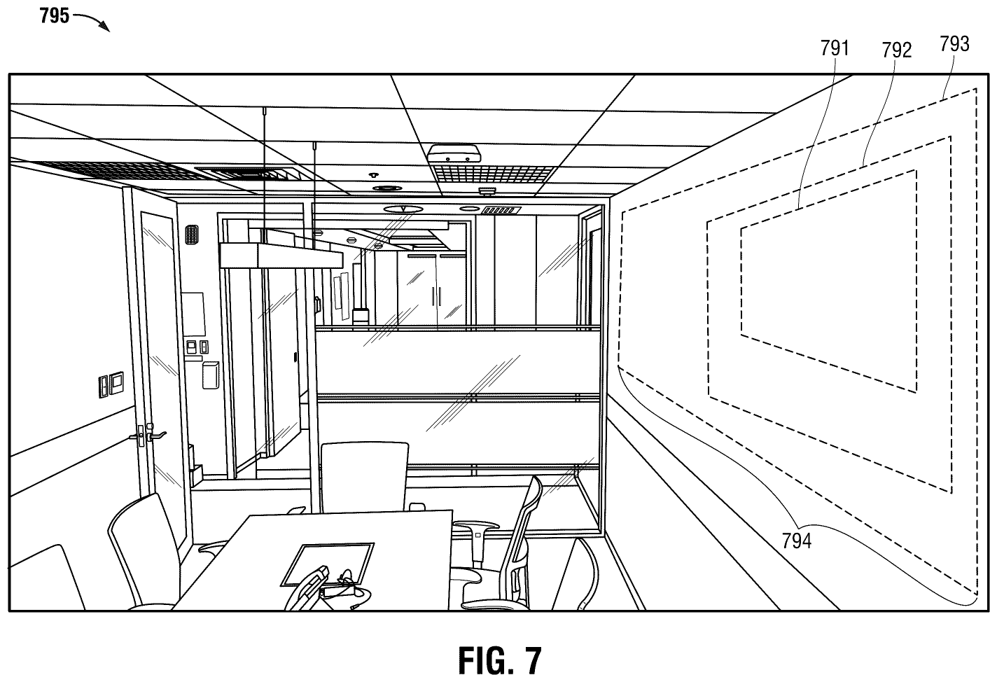

FIG. 7 is a graphical diagram illustrating a plurality of differently sized presentation areas of a planar presentation surface of an image captured of a viewing area by a web camera in which user-supplied presentation material may be provided during the course of a videoconferencing collaboration session to adjust the size of an identified presentation area and its boundaries when a planar presentation surface has difficult to define boundaries according to an embodiment of the present disclosure. As described herein, with increasing use of large surfaces for writing or drawing during such videoconferencing sessions, such as entire windows or entire walls of a planar presentation surface 794 of a video conference room in a viewing area image 795, the size and shape of a presentation area (e.g., 791, 792, or 793) in which the presenter provides such user-supplied presentation material can vary greatly during the course of a videoconferencing session when the boundaries of the planar presentation surface 794 are difficult to determine. For example, a presenter may initially present user-supplied presentation material such as handwriting or drawing on the planar presentation surface 794, but execution of the dynamic presentation area captured image normalizing system may initially determine that the smaller presentation area 791 is the identified presentation area toward the beginning of the videoconferencing session.

As the session progresses, however, and further information is discussed, more handwriting or drawing may be added outside of this initial identified presentation area 791, which may increase the size of the area in which the user-supplied presentation material is identified to be added by the dynamic presentation area captured image normalizing system such that the identified presentation area is expanded to include presentation area 792, or even 793. Thus, despite boundary identification of the planar presentation surface 794 being difficult and hard to define, the dynamic presentation area captured image normalizing system may learn and adjust to determine the identified presentation area that will be needed or used as a polygon for translation of the user-supplied presentation material to an orthogonally-adjusted user-supplied presentation material for display alongside a video feed of the video conference. The dynamic presentation area captured image normalizing system in an embodiment can dynamically adjust the recognized size and shape of the identified presentation area (e.g., from 791 to 792 or 793) by automatically resizing the polygon (e.g., 580 of FIG. 5) determined to enclose machine-recognized user-supplied presentation material, as part of the process of generating the unobscured orthogonal-view images of that user-supplied presentation material.

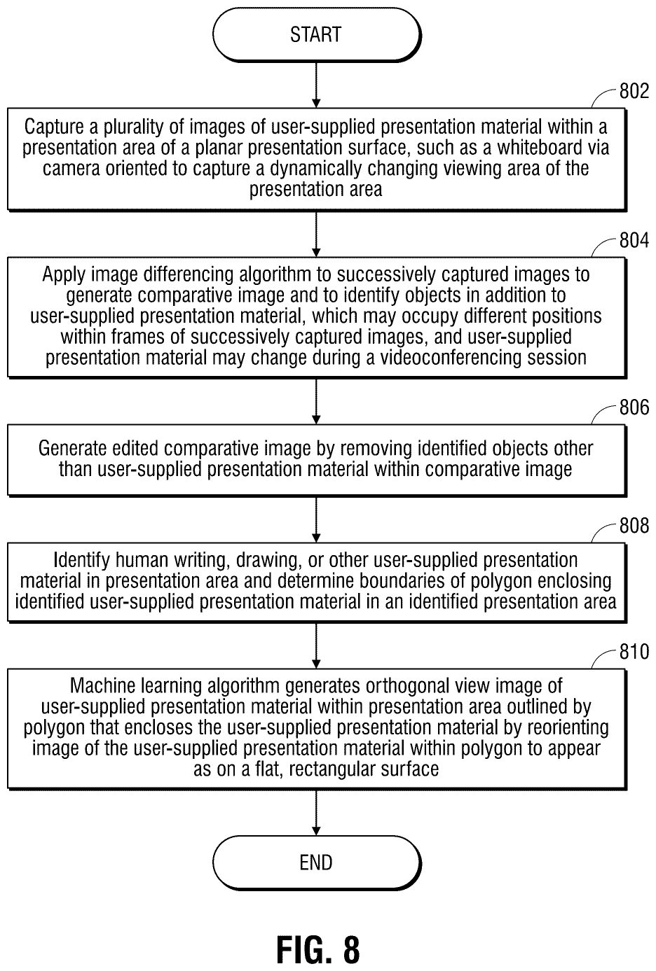

FIG. 8 is a flow diagram illustrating a method of a hardware processor executing code instructions of a videoconferencing application with a videoconferencing hardware system and the dynamic presentation area captured image normalizing system to generate an orthogonal view image of user-supplied presentation material displayed within a presentation area as a flat, rectangular surface that encloses the user-supplied presentation material, based on plural images captured by a web camera of a viewing area including an identified presentation area according to an embodiment of the present disclosure. As described herein, a hardware processor executing code instructions of the dynamic presentation area captured image normalizing system in an embodiment may dynamically adjust captured images of machine-identified, user-supplied presentation materials on a planar presentation surface such as a whiteboard to determine an identified presentation area and to exclude images other than the user-supplied presentation material, and reorient the captured images of the identified presentation area and the user-supplied presentation materials created on the planar presentation surface to dynamically display user-supplied presentation material from an orthogonal perspective of the identified presentation area, as would be viewed by a participant within the same room as the presentation area facing the planar presentation surface. As the viewing area capture by the fixed webcam changes, including with persons or furniture moving or obstructing the user-supplied presentation material, execution of code instructions of the dynamic presentation area captured image normalizing system provides for display of the user-supplied presentation material from an orthogonal perspective of the identified presentation area, which may be unobstructed, while dynamically updating changes to the user-supplied presentation material itself in embodiments herein.

At block 802, a plurality of images may be captured from a web camera of a viewing area, such as a conference room with a planar presentation surface, in an embodiment by the dynamic presentation area captured image normalizing system during a videoconference session. The dynamic presentation area captured image normalizing system further captures the viewing area including the planar presentation surface with and without user-supplied presentation material to determine an identified presentation area of the planar presentation surface, via a web camera oriented at what may be a less than ideal viewing angle with respect to the identified presentation area and the user-supplied presentation material. For example, in an embodiment described with respect to FIG. 2A, the captured image 260 of a viewing area may be the first of a plurality of images that may be captured in an embodiment. Such a captured image 260 of the viewing area of a web camera may or may not include user-supplied presentation material, such as handwriting, drawings, photos, or other user-supplied media placed by the user within an identified presentation area 290 corresponding to a planar presentation surface 291 in the viewing area image 260. In FIG. 2A, not user-supplied presentation material is shown. The planar presentation surface may be a bulletin board, dry-erase board, chalkboard, or any physical surface in which a user may write or draw within the viewing area image 260. The web camera capturing such images may be oriented at a less than ideal viewing angle with respect to the identified presentation area 290 of the planar presentation surface 291 and may identify the presentation area 290 if borders of the planar presentation surface 291 are discernable. In other embodiments, with difficult to identify borders of the planar presentation surface 291, a generalized location of presentation area 290 may be identified and updated as the presentation are become clearer when a presenter or presenters add user-supplied presentation material as described below. The captured image 260 may further capture objects surrounding the planar presentation surface 291 in the viewing area of the web camera, or located between the web camera and the planar presentation surface 291, such as the office chair 261, in various embodiments. In some cases, these objects may include the presenter, other participants of the session within the same physical room as the presenter, or any number of other objects that may obscure the camera's view of the user-supplied presentation material when on the planar presentation surface.

In another example embodiment described with respect to FIG. 2B, a second image 265 of the viewing area may be captured by the web camera that includes user-supplied presentation material 267. The user-supplied presentation material 267 may have been placed within an identified presentation area 290 and on the planar presentation surface 291 where the identified presentation are 290 based on identifiable borders of the planar presentation surface 291 are larger than the user-supplied presentation materials 267 as depicted in FIG. 2B. In other embodiments, where the boundaries or borders of the planar presentation surface in the viewing area are difficult to determine, the identified presentation are 290 may be identified around the user-supplied presentation material 267 in an embodiment. The captured image 265 of the viewing area may further capture objects, such as chair 261, in the viewing area surrounding the planar presentation surface 291, and which may move from the captured image 260 of FIG. 2A to the captured image 265 of FIG. 2B. In some embodiments, the objects, such as a presenter (not shown) in the viewing area of captured image 260 or 265 may be located between the web camera and the planar presentation surface 291 and may obstruct the identified presentation area 290 and the user-supplied presentation material 267 in various embodiments. However, as the object, such as the presenter moves, unobstructed images of the user-supplied presentation material 267 such at 265 in FIG. 2B, may be captured by the web camera in embodiments herein. Further, as the user-supplied presentation material 267 changes, additional captured images including the changes may be utilized by the code instructions of the dynamic presentation area captured image normalizing system according to embodiments herein.

An image differencing algorithm may be applied in an embodiment at block 804, via a hardware processor executing code instructions of the dynamic presentation area captured image normalizing system, to the successively captured images to generate a comparative image and to identify user-supplied presentation materials appearing on an identified presentation area or changes to the same as well as objects other than user-supplied presentation material within the viewing area of the plural images. Such objects may occupy different positions within frames of successively captured images, while the position of the identified presentation area may remain static although the user-supplied presentation material may change. As can be seen by comparing FIGS. 2A and 2B, the office chair 261 may have changed positions or location with respect to the web camera between capturing the image 260 and the image 265, such that the position of the office chain 261 within the frame of the image 265 of FIG. 2B has changed in comparison to the image 260 of FIG. 2A. Further, the user-supplied presentation material 267 may have appeared in image 265 of the viewing area of FIG. 2B where it was absent in image 269 if the viewing area FIG. 2A in an embodiment. FIG. 2A and FIG. 2B show unobstructed views of an identified presentation area, however, other objects may be captured within the image of the viewing area from the web camera, such as the presenter, other participants of the session within the same physical room as the presenter, or any number of other objects that may potentially temporarily obscure the camera's view of the user-supplied presentation material 267.

In order to present a clear image of the user-supplied presentation material, such as hand writing or drawing, for example, objects obscuring the user-supplied presentation material may be removed from captured images. An image differencing algorithm may be applied, via a hardware processor executing code instructions of the dynamic presentation area captured image normalizing system, to successively captured images, such as those described above with respect to FIGS. 2A and 2B. In order to perform such an image differencing or image subtraction method, the successively captured images may first be spatially aligned with one another to match features between them. Thus, in an example embodiment described with reference to FIG. 3, the hardware processor executing code instructions of the dynamic presentation area captured image normalizing system may combine the successively captured images from FIGS. 2A and 2B into a comparative image 370 to subtract out common image elements but keep an identified presentation area when the one or more features of these images are aligned with one another, such as one or more edges of the planar presentation surface that are identified as the presentation area borders 390.

Because the position of the camera with respect to the planar presentation surface 390 (e.g., whiteboard) does not change, any changes in the location of other objects within the frame of the comparative image 370 may indicate the presence of an object or person that could obscure the view of the user-supplied presentation material. For example, the comparative image 370 may include a first image 361-A of an office chair in a first position taken from the underlying captured image 260 of FIG. 2A, and a second image 361-B of the same office chair in a second position taken from the underlying captured image 265 of FIG. 2B. A hardware processor executing code instructions of an image differencing algorithm of the dynamic presentation area captured image normalizing system may compare pixel values of the comparative image 370 to identify objects, such as 361-A and 361-B that have moved between successively captured images underlying the comparative image 370. Further, the image differencing algorithm may further identify the user-supplied presentation material 367 that has appeared within the identified presentation area 390 in the image 265 of FIG. 2B but was absent from image 260 of FIG. 2A. This assists the execution of the dynamic presentation area captured image normalizing system to identify and save the user-supplied presentation material 367 in memory for orthogonal normalization and adjustment of that image portion to provide a normalized, front-facing view of the user-supplied presentation material 367 in embodiments herein. This saved user-supplied presentation material 367 relative to absence of user-supplied presentation material in a previous image (e.g., 260 of FIG. 2A) of the viewing area may provide for the dynamic presentation area captured image normalizing system to be able to dynamically update the user-supplied presentation material 367 within an identified user presentation area 390 as the video conference session progresses in embodiments herein.

At block 806, an edited comparative image may be generated in an embodiment, via a hardware processor executing code instructions of the dynamic presentation area captured image normalizing system, by removing identified objects other than the user-supplied presentation material within the identified presentation area the comparative image. For example, in an embodiment described with respect to FIG. 4, a hardware processor executing code instructions of an image differencing algorithm of the dynamic presentation area captured image normalizing system may further generate an edited comparative image 475 in an embodiment by removing those identified objects (e.g., 361-A and 361-B from FIG. 3) and leaving an unobscured view of the user-supplied presentation material 476.

A hardware processor executing code instructions of the dynamic presentation area captured image normalizing system in an embodiment at block 808 may identify human writing, drawing, or other user-supplied presentation material via an image recognition software algorithm that is machine-identified user-supplied presentation material located in the presentation area of the planar presentation surface as captured within the edited comparative image. With the image recognition of the user-supplied presentation material, the hardware processor executing code instructions of the dynamic presentation area captured image normalizing system may then determine the boundaries of a polygon enclosing the identified user-supplied presentation material that represents a machine-identified the presentation area. For example, in an embodiment described with respect to FIG. 4, the hardware processor executing code instructions of the dynamic presentation area captured image normalizing system may further identify with image recognition software human writing, drawing, or other user-supplied presentation material 476 that was captured within the edited comparative image 475. Any known or later-developed object detection algorithm or method of image recognition may be used in an embodiment, including machine-learning, deep-learning, or neural network techniques. Such techniques or models may more specifically use image recognition and object detection algorithms to identify human writing, human drawing, pictures, photographs, or even magnetic objects such as highlighting arrows or post-it notes added to the planar presentation surface to identify the user-supplied presentation material. The object detection algorithm or model of image recognition used to perform this task may be trained or directed to identify any of these types of user-supplied presentation materials. Upon determining the user-supplied presentation materials, the polygon around these user-supplied presentation materials may be generated for orthogonal adjustments to the user-supplied presentation material. In some embodiments, the generated polygon may also define the machine identified presentation area in the image of the planar presentation surface.

In another example embodiment described with respect to FIG. 5, the hardware processor executing code instructions of the dynamic presentation area captured image normalizing system may determine the boundaries by generation of a polygon 580 enclosing the identified user-supplied presentation material 567 that represents the identified presentation area within the edited comparative image 575. As can be seen in FIG. 5, the web camera that captured the raw images used to generate the edited comparative image 575 is oriented at a less then optimal viewing angle (e.g., not perpendicular or orthogonal to) the planar presentation surface upon which the user-supplied presentation material 567 has been provided. Thus, in order to provide a clearer, orthogonal view of the user-supplied presentation material 567, similar to that of a participant within the same room and sitting directly in front of the user-supplied presentation material 567, the edited comparative image 575 may be further adjusted by the hardware processor executing code instructions of the dynamic presentation area captured image normalizing system to reorient the angle at which the user-supplied presentation material 567 is presented.

In order to do this, the hardware processor executing code instructions of the dynamic presentation area captured image normalizing system in an embodiment may determine the boundaries of a polygon 580 enclosing the identified user-supplied presentation material 567. To a viewer within the room and sitting directly in front of this user-supplied presentation material 567 with an orthogonal view, such a polygon would appear as a rectangular area (e.g., with ninety degree angles). However, the polygon 580 shown in the captured image 575 is trapezoidal and skewed having acute or obtuse angles due to the distortion caused by the web camera angle to the planar presentation surface in the viewing area of the web camera.

At block 810, the edited comparative image 575 may be further adjusted via the hardware processor executing code instructions of the dynamic presentation area captured image normalizing system to reorient the image of the user-supplied presentation material 567 to map the trapezoidal image contents to rectangular image contents to remove this distortion. The hardware processor executing code instructions of the dynamic presentation area captured image normalizing system may generate an orthogonal view image of the user-supplied presentation material within the presentation area outlined by the polygon by reorienting the portion of the edited comparative image lying within the polygon to appear as a flat, rectangular surface that encloses the user-supplied presentation material.

For example, in an embodiment described with respect to FIG. 6, a hardware processor executing code instructions of the dynamic presentation area captured image normalizing system in an embodiment may map the trapezoidal polygon 580 and the contents of the user-supplied presentation materials 567 therein in FIG. 5 to a rectangular shape 680 as in FIG. 6 to generate an orthogonal view image 685 of the orthogonally-adjusted user-supplied presentation material 667 within the presentation area outlined by the polygonal rectangle 680. The mapping will further relate and translate the pixels of the contents of the user-supplied presentation materials 567 therein in FIG. 5 to fit as adjusted user-supplied presentation materials 667 in an orthogonal view image 685 within polygonal rectangle 680. This may be done by reorienting the portion of the edited comparative image (e.g., 575 of FIG. 5) lying within the polygon (e.g., 580) to appear as a flat, rectangular surface that encloses the user-supplied presentation material (e.g., 567) to shift pixel locations within the rectangular boundary 680 so that the orthogonally-adjusted user-supplied presentation material 667 appears proportionally across the polygonal rectangular boundary 680 for presentation to remote participants in a videoconference. In such a way, the hardware processor executing code instructions of the dynamic presentation area captured image normalizing system in an embodiment may dynamically adjust captured images of a presentation to exclude images other than the user-supplied presentation material, and reorient the captured images of the user-supplied presentation material to display from an orthogonal perspective as shown in 667 of FIG. 6 with respect to the presentation area bounded by a polygonal rectangle 680.

Such a presentation of the orthogonally-adjusted user-supplied presentation material 667 in FIG. 6 is similar to as it would be viewed by a participant within the same room as the presentation area having a frontal view. The method for generating an orthogonal view image of user-supplied presentation material displayed within a presentation area from a viewing area of an image capturing a planar presentation surface may then end. Moreover, as the contents of the user-supplied presentation materials 567 in the image 575 of FIG. 5 change or are obstructed, the hardware processor executing code instructions of the dynamic presentation area captured image normalizing system may update or replace obstructed images from later capture images of the viewing area including the identified presentation area from other periodically captured images and normalize those updated images to continue to present a current, unobstructed orthogonal view of user-supplied presentation materials 667 during a video conference session according to embodiments herein.

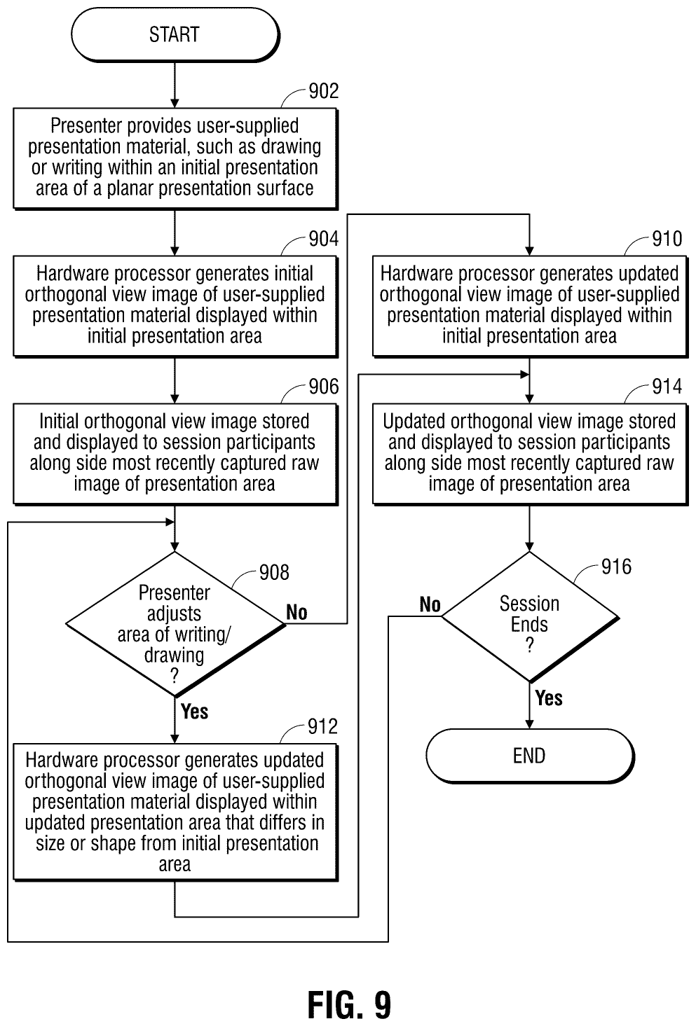

FIG. 9 is a flow diagram illustrating a method of adjusting an identified presentation area from a series of viewing area images a planar presentation surface with changing levels or sizes of user-supplied presentation material displayed within the captured images of the presentation area when the boundaries of the planar presentation surface is hard to detect or changes in shape and size during a presentation session according to embodiments of the present disclosure. As user-supplied presentation content is added or subtracted from the presentation area on a planar presentation surface with hard to detect boundaries, the sizing and shape of the identified presentation area with a polygon defining the identified presentation area may adjust and be updated from successive images of a viewing area such as a conference room by a hardware processor executing code instructions of a dynamic presentation area captured image normalizing system according to an embodiment of the present disclosure.

As described herein, because the dynamic presentation area captured image normalizing system in an embodiment may automatically determine and identify the presentation area in captured images of a planar presentation surface throughout the presentation, embodiments further dynamically adjust the size and shape of the identified presentation area as the presenter organically adds or subtracts such information on a poorly defined planar presentation surface. With increasing use of large surfaces for writing or drawing during such videoconferencing sessions, such as entire windows or entire walls of a conference room, the size and shape of an identified presentation area in which the presenter provides such user-supplied presentation material can be uncertain and vary greatly during the course of a videoconferencing session. Thus, boundary definition for the identified presentation area may be inaccurate relative to the size of the planar presentation surface in the image viewing area of the video conference room. The dynamic presentation area captured image normalizing system in embodiments of the present disclosure can dynamically adjust the recognized size and shape of the presentation area by automatically resizing the polygon determined to enclose machine-recognized user-supplied presentation material, including current and past content areas, as part of the process of generating the unobscured, orthogonal-view images of that user-supplied presentation material with execution of the dynamic presentation area captured image normalizing system, as described above with respect to FIG. 8. This resizing may further redefine the identified presentation area within the captured images from the web camera according to embodiments herein.

At block 902, a presenter participating in a video-conferencing or web presentation session in an embodiment may provide user-supplied presentation material, such as drawing or writing, within an initial presentation area of a planar presentation surface that is capture in an image of a viewing area by a web camera. For example, in an embodiment described with reference to FIG. 2A, upon the start of a collaborative presentation session, such as a video-conference or web presentation session between participants in different locations (e.g., different rooms or different geographic locations), a clean presentation area 290 may be captured in an image. As the collaborative presentation session progresses, a presenter may provide user-supplied presentation material, such as writing 267 as shown in FIG. 2B within an initial presentation area 290 of a planar presentation surface 291 in the image 265 of the viewing areas such as a video conference room. In another example embodiment described with reference to FIG. 7, a presenter may initially provide user-supplied presentation material within the smallest, initial identified presentation area 791.

A hardware processor at block 904 in an embodiment may execute code instructions of the dynamic presentation area captured image normalizing system to generate an initial orthogonal view image of user-supplied presentation material displayed within the initial presentation area by translating a trapezoidal polygonal boundary of the presentation area to a rectangular polygonal boundary for an orthogonal presentation of the user-supplied presentation material which is also proportionally translated from the skewed image to be displayed across the rectangular boundary of the orthogonally presented image. This may be accomplished using the method of executing code instructions of the dynamic presentation area captured image normalizing system described above with respect to FIG. 8 in order to generate an orthogonal view of user-supplied presentation material, such as that shown in FIG. 6, above.

At block 906, the initial orthogonal view image generated at block 904 of the user-supplied presentation material may be stored or displayed to remote session participants. In some embodiments, such an initial orthogonal view image may be displayed alongside recently captured raw image video feed of the presentation area that includes the presenter, physical objects, such as people or furniture and other aspects of the video conferencing room that are omitted from the initial orthogonal view image of the user-supplied presentation material. For example, in an embodiment described with respect to FIGS. 2A and 2B, the video conference may present to remote participants to view the raw, unprocessed video images, such as 260 and 265 as they are being recorded, in order to view the presenter and participants in the same room with the planar presentation surface 291 and interact actions with that planar presentation surface 290. Thus, in some embodiments, the raw captured images, such as 260 of FIG. 2A and 265 of FIG. 2B and those in between of the video may be displayed and alongside them the processed images that focus attention on the user-supplied presentation material 267 with an orthogonal view of the transitioned and adjusted orthogonally-adjusted user-supplied presentation material 667 as shown in FIG. 6 after execution of the dynamic presentation area captured image normalizing system.

In another example described with respect to FIG. 6, a series of orthogonal view images (e.g., 685) may be generated throughout the duration of a presentation session, as orthogonally-adjusted user-supplied presentation material 667 is added or subtracted from the planar presentation surface it may be updated in the orthogonal view of the orthogonally-adjusted user-supplied presentation material 667 from additional images of the video conference processed as described above in FIG. 8 by the dynamic presentation area captured image normalizing system. Each of these generated orthogonal view images 685 may be stored or displayed to remote session participants with updated orthogonal views of the orthogonally-adjusted user-supplied presentation material 667. In some embodiments, such an initial orthogonal view image 685 may be displayed alongside an ongoing video feed of the presentation area including physical objects, such as people or furniture, with the orthogonal view image of the user-presentation material periodically updated, as described directly above. Any orthogonal view images, such as 685, may be transmitted to a remote participant in the videoconferencing collaboration session either during, or after the presentation.

In some situations, a planar presentation surface in a video conference room may have difficult-to-determine borders. A presenter in an embodiment at block 908 may adjust the area of writing, drawing, or application of other user-supplied presentation material on the planar presentation surface that may extend the previously identified presentation area borders. For example, in an embodiment described with reference to FIG. 2B, as the collaborative presentation session progresses, one or more presenters may provide additional user-supplied presentation material 267 or remove such user-supplied presentation material through erasing. This addition or subtraction of user-supplied presentation material 267 may cause the portion of the planar presentation surface 291 that is an identified presentation area 290 in which such user-supplied presentation material 267 is provided to increase or decrease throughout the duration of the session.

In another example embodiment described with respect to FIG. 7, with increasing use of large surfaces for writing or drawing during such videoconferencing sessions, such as entire windows or entire walls 794 of a conference room 795, the size and shape of a presentation area (e.g., 791, 792, or 793) in which the presenter provides such user-supplied presentation material can vary greatly during the course of a videoconferencing session. More specifically, a presenter may initially present user-supplied presentation material such as handwriting or drawing within the smaller presentation area 791, toward the beginning of the videoconferencing session. As the session progresses, however, and further information is discussed, more handwriting or drawing may be added outside of this initial presentation area 791, which may increase the size of the area in which the user-supplied presentation material is identified to include presentation area 792, or even 793.

If the presenter does not adjust the area of user-supplied presentation material by adding or subtracting such material within the planar presentation surface, the method may proceed to block 910 for continued periodic generation of updated orthogonal view images showing a presentation area with the user-supplied presentation material adjusted for orthogonal viewing according to embodiments herein and having the same dimensions as the initial presentation area. If the presenter adjusts the area of user-supplied presentation material by adding or subtracting such material within the planar presentation surface, the method may proceed to block 912 for generation of an adjusted, identified presentation area for an updated orthogonal view image showing the updated, identified presentation area having the different dimensions then the initial presentation area due to a new polygon boundary around the current update of the user-supplied presentation material which reflects the addition or subtraction of user-supplied presentation material.

At block 910, in an embodiment in which the presenter does not adjust the area of user-supplied presentation material following generation of the initial orthogonal view image, the hardware processor executing code instructions of the dynamic presentation area captured image normalizing system to periodically generate updated orthogonal view images of the user-supplied presentation materials. As the user-supplied presentation materials are changed they are displayed from within the initial identified presentation area either from identified boundaries of the planar presentation surface or via the polygonal perimeter defined around the user-supplied presentation material according to various embodiments herein. In an embodiment described with reference to FIG. 7, the presenter may not add any user-supplied presentation material outside of the smallest presentation area 791. In such a case, the size or shape of the polygon surrounding the user-supplied presentation material, as determined by the hardware processor executing code instructions of the dynamic presentation area captured image normalizing system (e.g., as determined at block 808 of FIG. 8) and may remain the same as the polygon used to generate the most recent orthogonal view image of the presentation area. Thus, the hardware processor executing code instructions of the dynamic presentation area captured image normalizing system may use a polygon of the same size and shape as the previously used polygon to perform step 810 of FIG. 8 to generate an updated orthogonal view image of the user-supplied presentation material.

In an embodiment at block 912 in which the presenter adjusts the area of user-supplied presentation material following generation of the initial orthogonal view image, the hardware processor executing code instructions of the dynamic presentation area captured image normalizing system may determine updated boundaries of an identified presentation area and generate an updated orthogonal view image of the user-supplied presentation material displayed within the identified, updated presentation area that differs in size or shape from the initial presentation area. The updated, identified presentation area for the viewing area in the captured image from the web camera may be stored and saved for later user as the boundary of the planar presentation surface is further revealed and determined by the dynamic presentation area captured image normalizing system. For example, in an embodiment described with respect to FIG. 7, a presenter may initially present user-supplied presentation material such as handwriting or drawing within the smaller presentation area 791, toward the beginning of the videoconferencing session. As the session progresses, however, and further information is discussed, more handwriting or drawing may be added outside of this initial presentation area 791, which may increase the size of the area in which the user-supplied presentation material is identified via a polygon boundary around the machine detected user-supplied presentation material. This expansion of the identified presentation area may include presentation area 792, or even 793 as illustrated in FIG. 7 and may represent the polygon recognized by the dynamic presentation area captured image normalizing system as containing the user-supplied presentation material. The updated, identified presentation area (e.g., 792 or 793) may then be stored as the identified presentation area by the dynamic presentation area captured image normalizing system.

At block 914, the hardware processor in an embodiment may then execute code instructions of the dynamic presentation area captured image normalizing system, as described in FIG. 8 above, to generate an updated orthogonal view image of the user-supplied presentation material as recognized within the updated presentation area that differs in size or shape from the initial presentation area if the user adjusts the area of the user-supplied presentation material at block 908. Alternatively, the hardware processor in an embodiment may then execute code instructions of the dynamic presentation area captured image normalizing system, as described in FIG. 8 above, to generate an updated orthogonal view image of adjustments to the content of user-supplied presentation material recognized within the same initial identified presentation area if the user does not adjust the area of the user-supplied presentation material at block 908.

Upon generation of an updated orthogonal view image in an embodiment at block 914, the updated orthogonal view image may be stored and displayed to remote session participants. In some embodiments, such an updated orthogonal view image may be displayed alongside a video feed from the viewing area from the web camera of the video conference so that a remote participant may better view the user-supplied presentation material from a planar presentation surface such as a whiteboard within the video conference room while also participating in the video conference. Any orthogonal view images may be transmitted to a remote participant in the videoconferencing collaboration session either during, or after the presentation in some embodiments.

At block 916, it may be determined whether the presentation session has ended. If the presentation session has not ended, the method may proceed back to block 908 where a presenter may further add or subtract user-supplied presentation material falling inside or outside of the most recently updated presentation area. If the presentation session has ended, the method for displaying a series of orthogonal view images of user-supplied presentation material displayed within captured images of a presentation area that changes in shape and size during a presentation session may then end. By repeating the loop from block 908 to 916 in such a way, the hardware processor executing code instructions of the dynamic presentation area captured image normalizing system in an embodiment may dynamically adjust captured images of a presentation to exclude images other than the user-supplied presentation material, reorient the captured images to display from an orthogonal perspective with respect to the presentation area, and adaptively resize the orthogonal perspective image as the presenters change the size of the presentation area by adding or subtracting content.

The blocks of the flow diagrams of FIGS. 8 and 9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing computer readable code instructions of a dynamic presentation area captured image normalizing system comprising:
a network interface device to transceive video and audio data pursuant to a hardware processor executing computer readable code instructions of a videoconferencing software application during a videoconferencing session;
a camera operatively coupled to the hardware processor to capture from a video feed a plurality of raw images of a viewing area including an identified presentation area at a planar presentation surface in the viewing area where user-supplied presentation material is added by a user during the videoconferencing session;
a hardware processor to execute computer readable code instructions of the dynamic presentation area captured image normalizing system to identify the identified presentation area in a first raw image of the viewing area;
the hardware processor to execute computer readable code instructions of the dynamic presentation area captured image normalizing system to identify applied user-supplied presentation material within the identified presentation area of a second raw image of the viewing area;
the hardware processor to execute code instructions to determine boundaries of a skewed polygon enclosing the applied user-supplied presentation material;
the hardware processor to execute code instructions to translate the skewed polygon and the applied user-supplied presentation material to orthogonally-adjusted user-supplied presentation material within a rectangular polygon by proportionally reorienting the applied user-supplied presentation material pixels from the second raw image across the rectangular polygon to appear as orthogonally oriented; and
the network interface device to transmit an orthogonal view image of the orthogonally-adjusted user-supplied presentation material to a remote participant in the videoconferencing session.

2. The information handling system executing computer readable code instructions of the dynamic presentation area captured image normalizing system of claim 1, wherein a third raw image of the viewing area including updated applied user-supplied presentation material changed by a presenter is captured and the hardware processor executes code instructions to translate the skewed polygon and the updated applied user-supplied presentation material from the third raw image of the viewing area to generate updated orthogonally-adjusted user-supplied presentation material for presentation to the remote participant.

3. The information handling system executing computer readable code instructions of the dynamic presentation area captured image normalizing system of claim 1, wherein the applied user-supplied presentation material includes hand writing applied to the planar presentation surface in the viewing area which is identified by execution of an image recognition algorithm of the dynamic presentation area captured image normalizing system.

4. The information handling system executing computer readable code instructions of the dynamic presentation area captured image normalizing system of claim 1 further comprising:
the hardware processor to execute code instructions of an image-differencing algorithm in the dynamic presentation area captured image normalizing system to subtract the second raw image from the first raw image to remove the visual area of the raw images leaving the applied user-supplied presentation material in a composite image.

5. The information handling system executing computer readable code instructions of the dynamic presentation area captured image normalizing system of claim 4 further comprising:
the hardware processor to execute code instructions of an editing algorithm in the dynamic presentation area captured image normalizing system to remove an identified object other than the user-supplied presentation material.

6. The information handling system executing computer readable code instructions of the dynamic presentation area captured image normalizing system of claim 1 further comprising:
the network interface device to transmit the orthogonal view image of the orthogonally-adjusted user-supplied presentation material to the remote participant with the video feed of the videoconferencing session.

7. The information handling system executing computer readable code instructions of the dynamic presentation area captured image normalizing system of claim 1 further comprising:
the network interface device to transmit the orthogonal view image of the orthogonally-adjusted user-supplied presentation material to the remote participant after the videoconferencing session ends.

8. A method of generating an orthogonal view of a user-supplied presentation material within a dynamically sized presentation area during a videoconferencing collaboration session executing at an information handling system comprising:
capturing, via a camera, during a videoconferencing session, a first user-supplied material in a first presentation area of a planar presentation surface oriented at a viewing angle with respect to the camera in a first raw image, and a second user-supplied material in a second presentation area of the presentation surface in a second raw image;
identifying, via a hardware processor executing code instructions of an object identification machine-learning model of a dynamic presentation area captured image normalizing system, the first user-supplied presentation material within the first raw image;
determining, via the hardware processor, boundaries of a first polygon enclosing the first user-supplied presentation material within the first raw image to determine a first identified presentation area of the planar presentation surface;
identifying, via a hardware processor executing code instructions of an object identification machine-learning model of a dynamic presentation area captured image normalizing system, the second user-supplied presentation material within the second raw image boundaries of a second polygon having a different size or shape than the first polygon, where the second polygon encloses the second user-supplied presentation material within the second raw image and identifies a second identified presentation area of the planar presentation surface; and
generating, via the hardware processor, orthogonally-adjusted second user-supplied presentation material in the composite image by translating the second user-supplied presentation material within the second polygon that is skewed by proportionally reorienting second applied user-supplied presentation material pixels of the second user-supplied presentation material across a rectangular polygon to appear as orthogonally oriented to yield the orthogonally-adjusted second user-supplied presentation material.

9. The method of claim 8 further comprising:
generating, via the hardware processor, orthogonally-adjusted first user-supplied presentation material by translating the first user-supplied presentation material within the first polygon by proportionally reorienting first user-supplied presentation material pixels of the first user-supplied presentation material across the rectangular polygon to appear as orthogonally oriented to yield the orthogonally-adjusted first user-supplied presentation material prior to capturing the second raw image.

10. The method of claim 8, wherein the second user-supplied presentation material is an expansion of and includes the first user-supplied presentation material.

11. The method of claim 8 further comprising:
transmitting, via a network interface device, the orthogonally-adjusted second user-supplied presentation material to a remote participant in the videoconferencing session.

12. The method of claim 8 further comprising:
removing, via the hardware processor executing an image-differencing algorithm, a plurality of features of a viewing area in the first raw image and the second raw captured by the camera image except for the first user-supplied presentation material or the second user-supplied presentation material in a composite image.

13. The method of claim 12 further comprising:
executing, via the hardware processor, code instructions of the dynamic presentation area captured image normalizing system to edit the composite image to remove objects other than the first user-supplied presentation material or the second user-supplied presentation material that remain in the composite image.

14. The method of claim 8 further comprising:
transmitting, via the network interface device, an orthogonal view image of the orthogonally-adjusted second user-supplied presentation material to a remote participant with a video feed of the videoconferencing session.

15. A videoconferencing web camera hardware system executing computer readable code instructions of a dynamic presentation area captured image normalizing system comprising:
a network interface device to transceive video and audio data pursuant to a hardware processor executing computer readable code instructions of a videoconferencing software application during a videoconferencing session;
a camera operatively coupled to the hardware processor to capture from a video feed a plurality of raw images of a viewing area including an identified presentation area at a planar presentation surface in the viewing area;
a hardware processor to execute computer readable code instructions of the dynamic presentation area captured image normalizing system to identify the identified presentation area in a first raw image of the viewing area;
the hardware processor to execute computer readable code instructions of the dynamic presentation area captured image normalizing system to identify applied user-supplied presentation material within the identified presentation area of a second raw image of the viewing area;
the hardware processor to execute code instructions of an image subtraction algorithm of the dynamic presentation area captured image normalizing system to eliminate a plurality of features of the viewing area while preserving the applied user-supplied presentation material in a composite image;
the hardware processor to execute code instructions to determine boundaries of a skewed polygon enclosing the applied user-supplied presentation material and to translate the skewed polygon and the applied user-supplied presentation material to orthogonally-adjusted user-supplied presentation material within a rectangular polygon by proportionally reorienting the applied user-supplied presentation material pixels from the composite image across the rectangular polygon to appear as orthogonally oriented; and
the network interface device to transmit an orthogonal view image of the orthogonally-adjusted user-supplied presentation material to a remote participant in the videoconferencing session.

16. The videoconferencing web camera hardware system of claim 15, wherein a third raw image of the viewing area including updated applied user-supplied presentation material changed by a presenter is captured and the hardware processor executes code instructions to translate the skewed polygon and the updated applied user-supplied presentation material from the third raw image of the viewing area to generate updated orthogonally-adjusted user-supplied presentation material for presentation to the remote participant.

17. The videoconferencing web camera hardware system of claim 15, wherein the applied user-supplied presentation material is identified by execution of an image recognition algorithm of the dynamic presentation area captured image normalizing system.

18. The videoconferencing web camera hardware system of claim 15 further comprising:
the hardware processor to execute code instructions of an editing algorithm in the dynamic presentation area captured image normalizing system to remove an identified object other than the applied user-supplied presentation material in the composite image.

19. The videoconferencing web camera hardware system of claim 1 further comprising:
the network interface device to transmit the orthogonal view image of the orthogonally-adjusted user-supplied presentation material to the remote participant with the video feed of the videoconferencing session.

20. The videoconferencing web camera hardware system of claim 1 further comprising:
the network interface device to transmit the orthogonal view image of the orthogonally-adjusted user-supplied presentation material to the remote participant after the videoconferencing session ends.
